(19) United States
(12) Patent Application Publication
(10) Pub. No.: US 2010/0130630 A1
(43) Pub. Date: May 27, 2010

(54) PROCESS FOR PREPARING A TRIBLOCK COPOLYMER COMPRISING A SEMI-CRYSTALLINE AND/OR HYDROLYSABLE BLOCK, AN ELASTOMERIC BLOCK AND AN AMORPHOUS BLOCK

(75) Inventors: Nelly Chagneux, Marseille (FR); Thomas Trimaille, Marseille (FR); Denis Bertin, Marseille (FR); Pierre Gerard, Denguin (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, COLOMBES (FR)

(21) Appl. No.: 12/442,201

(22) PCT Filed: Sep. 19, 2007
(86) PCT No.: PCT/EP2007/059913

§ 371 Date: Jan. 4, 2010

(30) Foreign Application Priority Data
Sep. 20, 2006 (FR) 06 53847

(51) Int. Cl. C08F 2/38; C08J 5/18; C08G 63/20

(52) U.S. Cl. 521/134; 525/340; 525/194; 525/88; 524/502

(57) ABSTRACT

The invention relates to a process for the preparation of a block copolymer comprising a sequence successively comprising a semicrystalline and/or hydrolysable block, an elastomeric block and an amorphous block, comprising the following stages:
a) a stage of 1,2-addition, to a terminal ethylenic group of a semicrystalline and/or hydrolysable polymer, of an alkoxyamine which can correspond to the following formula (II):

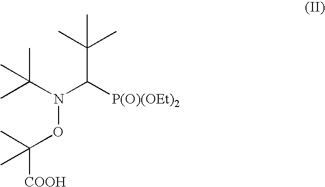

b) a stage of addition, to the medium resulting from stage a), of one or more monomers which are precursors of the elastomeric block, in return for which a semicrystalline and/or hydrolysable block-b-elastomeric block diblock copolymer is obtained;
c) a stage of addition, to the medium resulting from stage b), of one or more monomers which are precursors of the amorphous block, in return for which the semicrystalline and/or hydrolysable block-b-elastomeric block-b-amorphous block triblock copolymer is obtained.

Application of the copolymers obtained as impact modifier for amorphous matrices.

### TECHNICAL FIELD

The invention relates to a process for the preparation of a triblock copolymer, comprising a semicrystalline and/or hydrolysable block, an elastomeric block and an amorphous block, by controlled radical polymerization employing a specific alkoxyamine.

The triblock copolymers thus prepared can be applied in particular in fields requiring recourse to materials with a very high tensile strength and can be used in particular as impact modifier for a matrix made of brittle amorphous polymer.

When one of the blocks is hydrolysable, these copolymers can be applied in the formation of nanoporous films or also as ingredient of antifouling paint.

### BACKGROUND ART

Block copolymers comprising a semicrystalline block, an elastomeric block and an amorphous block have been essentially prepared to date by ionic polymerization, such as anionic polymerization or cationic polymerization.

Thus, Balsamo et al. (Macromolecular Chemistry and Physics, 1996, 197, 1159-1169) have described the preparation of a polystyrene-b-polybutadiene-b-poly(ε-caprolactone) triblock copolymer by successive anionic polymerization of styrene, butadiene and finally ε-caprolactone after modification of the chain end of the polystyrene-b-polybutadiene diblock copolymer with diphenylethylene.

Abetz et al. (Macromolecules, 2001, 34, 8720-8729) have described the synthesis of a polystyrene-b-poly(ethylene-alt-propylene)-b-polyethylene (PS-b-PEP-b-PE) block copolymer, where PE represents the semicrystalline block, PS represents the amorphous block and PEP represents the elastomeric block, this synthesis being carried out by sequential anionic polymerization of styrene, isoprene and 1,4-butadiene, followed by partial hydrogenation of the polyisoprene and polybutadiene blocks, to result in the abovementioned triblock copolymer.

Faust and Kwon (Journal of Macromolecular Science, Part A: Pure and Applied Chemistry, 2004, 42, 385-401) have described the synthesis of a poly(α-methylstyrene)-b-polyisobutylene-b-polypivalactone block copolymer, where the amorphous nature is conferred by the poly(α-methylstyrene), the elastomeric nature is conferred by the polyisobutylene and the semicrystalline nature is conferred by the polypivalactone, this synthesis being carried out by successive cationic polymerizations of the α-methylstyrene and the isobutylene, followed by the anionic polymerization of the pivalactone subsequent to chemical modification at the chain end of the poly(α-methylstyrene)-b-polyisobutylene diblock copolymer.

Bates et al. (Macromolecules, 2001, 34, 6994-7008) have described the synthesis of a polystyrene-b-polyisoprene-b-polyethylene oxide triblock copolymer from a sequential process combining the anionic polymerization of styrene, isoprene and ethylene oxide.

Hillmyer (Chemical Materials, 2006, 18, 1719-1721) has described in particular poly(lactic acid)-b-polyisoprene-b-polystyrene block copolymers comprising an elastomeric polyisoprene block, an amorphous polystyrene block and a biodegradable poly(lactic acid) block, these copolymers being synthesized by anionic polymerization of the styrene and the isoprene and by coordination-insertion polymerization of the lactic acid in the presence of triethylaluminium.

These various processes, based on ionic (cationic and/or anionic) polymerization, have a number of disadvantages, in the sense that they are very sensitive to traces of impurities in the solvents and in particular to traces of water. Furthermore, they do not make it possible to provide control of the polymerization reactions of a wide range of monomers.

Some authors have described the use of the controlled radical polymerization technique using, as macroinitiator, a polycaprolactone activated by an end, referred to as TEMPO, of formula:

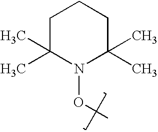

the square bracket indicating the place via which the TEMPO end is attached to the polycaprolactone.

This activated polycaprolactone, called PCL-TEMPO, is used as living polymer to polymerize styrene, in order to constitute a polycaprolactone-b-polystyrene diblock copolymer. It is restricting to envisage the synthesis of a polycaprolactone-b-poly(n-butyl acrylate) diblock copolymer from PCL-TEMPO, insofar as the control of polymerization of the n-butyl acrylate by the TEMPO nitroxide can only be provided by controlled addition of ascorbic acid to the reaction medium.

There thus exists a true need for a process for the preparation of a (semicrystalline and/or hydrolysable block)-b-(elastomeric block)-b-(amorphous block) triblock copolymer which makes possible control of the polymerization of each of the blocks and which furthermore does not require operating conditions as demanding as those of ionic polymerization or also radical polymerization with an initiator of the TEMPO type as defined above.

This need is fulfilled by the invention which is the subject of the description given below.

### ACCOUNT OF THE INVENTION

The invention thus relates, according to a first subject-matter, to a process for the preparation of a triblock copolymer comprising a semicrystalline and/or hydrolysable block, an elastomeric block and an amorphous block, comprising the following stages:

a) a stage of 1,2-addition, to a terminal ethylenic group of a semicrystalline and/or hydrolysable polymer, of an alkoxyamine corresponding to the following formula (I):

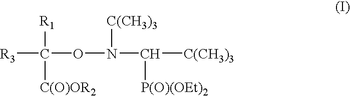

in which:
R₁ and R₃, which are identical or different, represent a linear or branched alkyl group having a number of carbon atoms ranging from 1 to 3;
R₂ represents a hydrogen atom, an alkali metal, such as Li, Na or K, an ammonium ion, such as NH₄⁺, NBu₄⁺ or NHBu₃⁺, a linear or branched alkyl group having a number of carbon atoms ranging from 1 to 8, or a phenyl group;

b) a stage in which the medium resulting from stage a) is brought into contact with one or more precursor monomers of the elastomeric block for a time sufficient to obtain a semicrystalline and/or hydrolysable block-b-elastomeric block diblock copolymer;

c) a stage in which the medium resulting from stage b) is brought into contact with one or more precursor monomers of the amorphous block for a time sufficient to obtain the semicrystalline and/or hydrolysable block-b-elastomeric block-b-amorphous block triblock copolymer.

Before entering any more detail into the description, it is specified that the terms “precursor monomer of the elastomeric block” and “precursor monomer of the amorphous block” are understood to mean the monomers, which, after polymerization, will respectively constitute the repeat units of the elastomeric block and of the amorphous block.

It is specified that Et is understood to mean an ethyl group and Bu is understood to mean a butyl group which can exist in its various isomers.

The innovative nature of this process lies very particularly in:
the 1,2-addition of the alkoxyamine to an ethylenic group of a semicrystalline and/or hydrolysable polymer intended to constitute the semicrystalline and/or hydrolysable block;
the resumption of controlled radical polymerization from the semicrystalline and/or hydrolysable polymer activated by a group resulting from the alkoxyamine, this resumption of polymerization making it possible to obtain the elastomeric block covalently attached to the semicrystalline and/or hydrolysable block;
the resumption of controlled radical polymerization from the semicrystalline and/or hydrolysable block-b-elastomeric block diblock copolymer, one end of the elastomeric block of which is activated by a group resulting from the alkoxyamine;
the controlled nature of the polymerization stages.

A reaction scheme will be explained below, starting from a specific example.

In stage a) of the process, a semicrystalline and/or hydrolysable polymer is brought into contact with an alkoxyamine of formula (I), this alkoxyamine being capable of reacting with the ethylenic group of the polymer according to a 1,2-addition reaction.

The semicrystalline and/or hydrolysable polymer can be:
a nonhydrolysable semicrystalline polymer, such as polyethylene, polypropylene, polyethylene oxide and polyamides;
a hydrolysable semicrystalline polymer, such as polymers resulting from a polycondensation reaction, for example polycaprolactones, L-polylactide and poly(L-lactide-co-glycolic acid) copolymers;
a hydrolysable non-semi-crystalline polymer, such as DL-polylactide and poly(DL-lactide-co-glycolic acid) copolymers.

In the continuation of this account, the term “polylactide” is understood to mean poly-L-lactides and poly-DL-lactides.

These polymers can be prepared beforehand or can be purchased from appropriate suppliers.

It is specified that the term “hydrolysable polymer” is understood to mean a polymer capable of being split into its repeat units by hydrolysis in an aqueous medium, it being possible for this hydrolysis to be carried out in an acidic or basic medium according to the nature of the polymer.

The process according to the invention can comprise a stage prior to stage a), referred to as functionalization stage, intended to introduce a terminal ethylenic group at the end of a starting semicrystalline and/or hydrolysable polymer, when the terminal ethylenic group does not inherently form part of this polymer.

For example, starting from a starting semicrystalline polymer comprising an —OH end, such as an α-hydroxylated polycaprolactone, it is necessary to react this polymer with a compound capable of introducing an ethylenic group by reaction with the —OH end. This compound can be chosen from acids, activated esters or acryloyl halides, such as acryloyl chloride, in which case the ethylenic group introduced is an acrylate group.

The reaction scheme, with acryloyl chloride as compound, can be as follows:

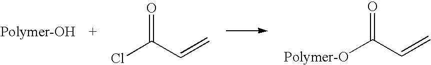

In accordance with the invention, the semicrystalline and/or hydrolysable polymer comprising an ethylenic group (intended to constitute the semicrystalline and/or hydrolysable block) is brought into contact with an alkoxyamine as defined above and reacts with it according to a 1,2-addition mechanism according to the following reaction scheme:

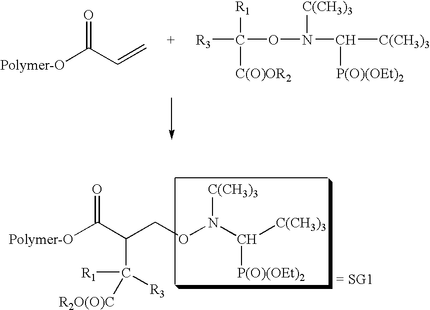

the nitroxide end subsequently being referred to as “SG1”.

The alkoxyamine is generally introduced in a content ranging from 0.5% to 80% by weight, with respect to the weight of the semicrystalline and/or hydrolysable polymer, the number-average molar mass Mn of which can be within the range extending from 1000 g.mol⁻¹ to 100 000 g.mol⁻¹ and preferably from 5000 g.mol¹ to 50 000 g.mol⁻¹.

A specific alkoxyamine which can be used in accordance with the invention is an alkoxyamine corresponding to the following formula (II):

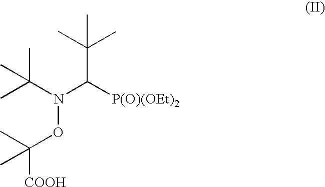

which may be referred to, in the continuation of this account, as “MAMA-SG1”.

The semicrystalline and/or hydrolysable polymer activated by an SG1 end constitutes a living polymer which will be able to act as basis for the control synthesis of a second block by polymerization of one of more monomers which are precursors of the elastomeric block.

The monomers introduced in stage b) which are precursors of the elastomeric block can be chosen from alkyl acrylates, such as n-butyl acrylate, and dienes, such as isoprene and butadiene.

It can be advantageous, in order to bring about the resumption of polymerization from the living semicrystalline and/or hydrolysable polymer obtained on conclusion of stage a), to add, during stage b), in addition to the monomers intended to constitute the elastomeric block, a solution comprising a control agent corresponding to the following formula:

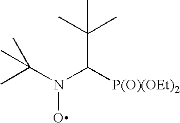

and a solvent for this control agent, it being possible for this solvent to be tert-butylbenzene (t-BuBz) or chlorobenzene, which solvent does not participate in the transfer reactions.

Thus, on conclusion of stage b), a (semicrystalline and/or hydrolysable block)-b-elastomeric block diblock copolymer activated at the end of the elastomeric block by a group of formula:

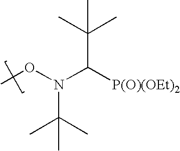

the square bracket indicating the place via which this group is attached to the end of the elastomeric block, is obtained.

By virtue of this activated end, the (semicrystalline and/or hydrolysable block)-b-elastomeric block diblock copolymer will be able to act as basis for the controlled synthesis of the third block by polymerization of one or more monomers which are precursors of the amorphous block.

The monomers introduced in stage c) which are precursors of the amorphous block can be chosen from alkyl methacrylates, such as methyl methacrylate, styrene, acrylic acid, alkylmethacrylamides or vinyl acetate.

Stages a), b) and c) are generally carried out under an inert gas atmosphere, for example a nitrogen atmosphere, by, for example, sparging nitrogen into the reaction system.

Stages a), b) and c) are also carried out at a temperature which can range from 20° C. to 180° C., preferably from 40° C. to 130° C.

The process of the invention can comprise, after stages a), b) and c), a stage of isolation of the living polymer, on conclusion of stage a), a stage of isolation of the diblock copolymer of stage b) and a stage of isolation of the triblock copolymer of stage c), for example by precipitation followed by filtration.

The process of the invention applies very particularly to the preparation of a triblock copolymer, in which:
the semicrystalline block is a polycaprolactone block;
the elastomeric block is a poly(n-butyl acrylate) block;
the amorphous block is a poly(methyl methacrylate) block.

From a structural viewpoint, the process according to the invention makes it possible to obtain (semicrystalline and/or hydrolysable block)-b-(elastomeric block)-b-(amorphous block) triblock copolymers exhibiting a terminal group bonded to the amorphous block exhibiting the following formula:

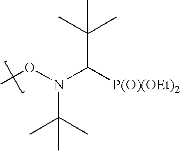

Thus, the invention relates, according to a second subject-matter, to a triblock copolymer capable of being obtained by the process of the invention.

These triblock copolymers, as a result of a sequence comprising a semicrystalline and/or hydrolysable block, an elastomeric block and an amorphous block, are thus able to have a high potential as impact modifier for brittle polymer matrices (for example, polymer matrices made of amorphous, thermosetting or semicrystalline polymer), it being possible for the triblock copolymer to be introduced in a content of 25 to 50% by weight, with respect to the weight of the matrix. This is because these triblock copolymers can self-assemble in the form of nanoparticles of the core-crown type, with a semicrystalline core, an elastomeric crown, making it possible to dissipate the stress experienced by the copolymer, and a crown made of amorphous polymer. In the case of a matrix made of amorphous polymer, the amorphous crown makes it possible for the nanoparticles to be compatible with the amorphous matrix to be modified.

The triblock copolymer according to the invention can be used to enhance the impact and/or impact resistance properties and/or the mechanical strength properties of a polymer matrix, which can be amorphous, thermosetting or semicrystalline. According to a specific embodiment of the invention, the polymer matrix is made of an amorphous polymer.

The polymer matrix can be made of epoxy, of unsaturated polyester, of polyethylene terephthalate, of polybutylene terephthalate, of polystyrene, of polyphenylene oxide, of polymethyl methacrylate, of polyvinylidene fluoride or of polycarbonate.

In particular, a triblock copolymer in accordance with the invention comprising an amorphous polystyrene or polymethyl methacrylate block can act as impact modifier in a matrix made of polystyrene, of polyethylene oxide, of polymethyl methacrylate, of polyvinylidene fluoride or of polycarbonate.

Thus, the invention relates to a composite material comprising a matrix made of amorphous, thermosetting or semicrystalline polymer, for example made of amorphous polymer, such as polymethyl methacrylate, and a triblock copolymer as defined above.

When the first block is hydrolysable, in addition optionally to being semicrystalline, it is also possible to envisage using the ability of this block to form cavities in numerous applications involving the formation of pores generated by the hydrolysis of this block.

Thus, it may be possible to envisage using these copolymers in the formation of nanoporous films, the hydrolysis of the hydrolysable core optionally making it possible to form pores in a film comprising nanoparticles.

Finally, it may be possible to envisage using these copolymers as ingredient in the field of antifouling paints, in particular in the nautical field. In outline, the nanostructuring of these copolymers in the form of cylinders would make possible, after decomposition of the hydrolysable block, the “square-wave” structuring of the paint layer, rendering the protected surface superhydrophobic and thus preventing the water but also the microorganisms present therein from being deposited on the sides of the boat.

The invention will now be described with reference to the following examples, given by way of illustration and without implied limitation.

### DETAILED ACCOUNT OF SPECIFIC EMBODIMENTS

### Example

### a) Preparation of Polycaprolactone Acrylate

An ω-hydroxylated polycaprolactone is dissolved in dichloromethane ([OH]=10⁻² mol.l⁻¹) in a three-necked round-bottomed flask. Finally, 25 equivalents of acryloyl chloride are added using a syringe. The mixture is left stirring at ambient temperature and under an inert atmosphere over the weekend (reaction time of greater than 60 hours). The dichloromethane is subsequently evaporated under vacuum. The polymer then occurs in the form of an oil. Once redissolved in tetrahydrofuran (THF), the poly-caprolactone comprising an acrylate group at its end is precipitated from cold methanol, filtered off on a sintered glass filter, rinsed with methanol and finally dried on a vacuum line for a few hours. The final polymer corresponds to a white powder. The functionalization yield, determined by ¹H NMR, is 100% according to this method of synthesis. The reaction time can be optimized by increasing the number of equivalents of acryloyl chloride or by increasing the concentration of the polymer in the medium. Thus, by using 100 equivalents of acryloyl chloride, it was possible to achieve a functionalization yield of 100% in 20 hours. Likewise, the reaction is complete in 20 hours when the concentration of the OH functional group is increased up to 2.5×10⁻² mol.l⁻¹, after having reduced the amount of solvent used during the reaction.

The polymer obtained corresponds to the following formula (III):

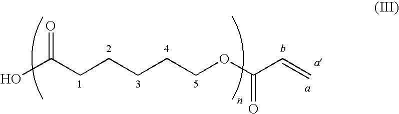

n corresponding to the number of repeat units, namely 88.

The results of NMR analysis are as follows:

¹H NMR (CDCl₃) (in ppm):

6.4 (dd, J_{a-b}=17.4 Hz, J_{a-a′}1.4 Hz), 6.1-6.2 (m), 5.8-5.9 (dd, J_{a′-b}=10.7, J_{a′-a}=1.2 Hz), 4.1 (t, J₅₋₄=6.65 Hz, 2H), 2.3 (t, J₁₋₂=7.45 Hz, 2H), 1.7 (m, 4H), 1.4 (m, 2H).

### b) 1,2-Addition of MAMA-SG1 to Polycaprolactone Acrylate

The polycaprolactone comprising a terminal acrylate group of formula (III) is introduced into a Schlenk tube equipped with a Rotaflo tap. A solution of MAMA-SG1 of following formula (II):

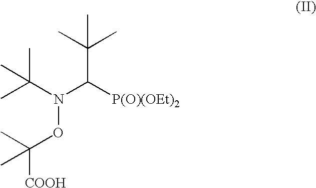

in THF is introduced onto the polycaprolactone of formula (III) (optimum concentration of the acrylate functional group 0.05 mol.l⁻¹). The suspension of polycaprolactone (III) in THF comprising MAMA-SG1 is deoxygenated by sparging with nitrogen for 30 minutes. Finally, the Schlenk tube is immersed in an oil bath at 100° C. for 1 hour. The medium rapidly homogenizes at 100° C. (the dissolution of the polymer being favoured by the melting thereof). Once the Schlenk tube has been cooled, the reaction medium is decanted into a single-necked round-bottomed flask with the THF used to rinse out the Schlenk tube. The medium is slightly reconcentrated by evaporation under vacuum at a maximum temperature of 30° C. in order not to damage the SG1 chain end. The polymer is subsequently precipitated from cold methanol, filtered off and rinsed with methanol. Finally, the polymer, corresponding to a white powder, is dried on a vacuum line.

This polymer corresponds to the following formula:

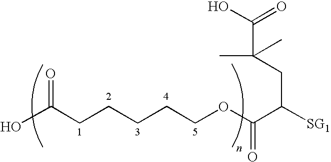

In the continuation of the example, this polymer is referred to as PCL-SG1.

Its living nature (100%) is determined by ³¹P NMR and EPR according to the studies published in the following papers: Bertin et al., e-Polymers, 2003, No. 2; Bertin et al., Macromolecules, 2002, 35, 3790-3791.

The results of NMR analysis are as follows:

¹H NMR (CDCl₃) (in ppm):

4.0 (t, J₅₋₄=6.15 Hz, 2H), 2.3 (t, J₁₋₂=7.1 Hz, 2H), 1.6 (m, 4H), 1.1 (m, 2H), 1.4 (s, H_{b}), 1.4 (s, Hₐ)

³¹P NMR (CDCl₃) (in ppm):

a peak at 24.43 ppm (major diastereoisomer, 85%) and a peak at 24.15 ppm (minor diastereoisomer, 15%).

### c) Polymerization of n-butyl acrylate initiated by PCL-SG1

The macroinitiator PCL-SG1 is introduced into a three-necked round-bottomed flask containing n-butyl acrylate. tert-Butylbenzene (t-BuBz) and a solution of SG1 in t-BuBz corresponding to 10 mol % of SG1 with respect to the macroinitiator are added to the three-necked round-bottomed flask. The reaction system is deoxygenated by sparging with nitrogen for 20 minutes and is then heated to 120° C. (temperature gradient over 20 minutes). The reaction is halted by stopping the heating after reacting for 2 h 30, the round-bottomed flask being immersed in a bath of ice-cold water. The medium is reconcentrated as much as possible under vacuum and then precipitated directly from cold methanol. A precipitate of the PCL-b-PBA diblock copolymer is thus obtained. The copolymer is subsequently filtered off, rinsed with methanol and dried on a vacuum line. The appearance of a diblock copolymer with Mₙ (PCL)=10 000 g.mol.⁻¹ and Mₙ (PBA)=20 000 g.mol⁻¹ corresponds to a sticky and slightly translucent solid.

The copolymer obtained corresponds to the following formula:

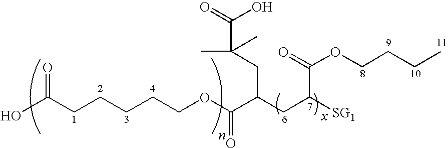

This copolymer is referred to in the continuation of the example as PCL-b-PBA-SG1.

This stage is fully controlled and living, in so far as:
in (M₀/M) is linear as a function of time (t) (M₀ being the molar mass of the copolymer at t₀ and M being the molar mass of the copolymer at time t);
the Mₙ changes linearly and in an increasing fashion with the conversion;
the PI (polydispersity index) of the PCL-b-PBA-SG1 copolymers is equal to that of the commercial PCL used as starting material, which means that there is no increase in the PI;
the % of SG1 at the chain end (i.e., in other words, the level of living chains) of the copolymers exceeds 85%.
   The NMR results are as follows:
   NMR (CDCl₃) (in ppm):

4.1 (m, H₅, H₈), 2.3 (t, H₁, H₇), 1.6 (m, 4H), 1.8 and 1.6 (m, H₂, H₄, H₆ and H₉), 1.4 (m, H₃, H₁₀) 0.93 (t, H₁₁).

³¹P NMR (CDCl₃) (in ppm):

a broad unresolved peak at 24.7 ppm and a broad unresolved peak at 24.23 ppm.

### d) Polymerization of methyl methacrylate by the PCL-b-PBA-SG1 copolymer

The PCL-b-PBA-SG1 copolymer, the methyl methacrylate (targeted theoretical molar mass of 450 000 g.mol⁻¹) and the t-BuBz are introduced into a three-necked round-bottomed flask. The reaction system is deoxygenated by sparging with nitrogen for 20 minutes and is then heated to 100° C. (temperature gradient over 15 minutes). The reaction is halted after reacting for 1 hour. The medium is diluted in THF and then precipitated from cold methanol. The polymer obtained is filtered off on a sintered glass filter, rinsed with methanol and dried on a vacuum line. The terpolymer obtained exists under the appearance of a filamentous white solid.

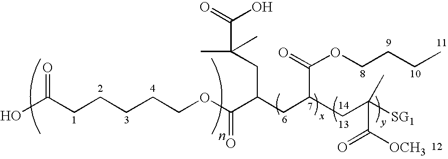

n, x and y corresponding to the number of repeat units put in brackets.

The NMR results are as follows:

¹H NMR (CDCIA (in ppm):

4.1 (m, H₅, He), 3.6 (m, H₁₂), 2.3 (t, H_{I}, H₇), 1.6 (m, 4H), 1.8 and 1.6 (m, H₂, H₄, H₆, H₉ and H₁₄), 1.4 (m, H₃, H₁₀), 0.9-1.04 (t, H₁₁ and H₁₃).

Three samples obtained in accordance with the process described above are described in the table below:
PCL corresponding to the polycaprolactone block,
PBA corresponding to the poly(n-butyl acrylate) block;
PMMA corresponding to the poly(methyl methacrylate) block;
PI corresponding to the polydispersity index.

| | | | | | | Residual |
|---|---|---|---|---|---|---|
| | PCL | | PBA | | PMMA | PCL-b-PBA- |
| | Mn | | Mn | | Mn | SG1 |
| Test | (g · mol⁻¹) | PI | (g · mol⁻¹ | PI | (g · mol⁻¹) | (in %) |
| NC31 | 10 000 | 1.7 | 22 500 | 1.6 | 54 100 | 31 |
| NC32 | 10 000 | 1.7 | 22 500 | 1.6 | 63 900 | 19 |
| NC33 | 10 000 | 1.7 | 22 500 | 1.6 | 99 500 | 15 |

On reading this table, it is found that the process of the invention exhibits a controlled nature and does not bring about an increase in the polydispersity index starting from a polycaprolactone exhibiting a PI of 1.7.

The copolymers prepared above are highly effective in improving the mechanical strength of polymethyl methacrylate.

1. Process for the preparation of a triblock copolymer comprising a semicrystalline and/or hydrolysable block, an elastomeric block and an amorphous block, comprising the following stages:
a) adding by a 1,2-addition, to a terminal ethylenic group of a semicrystalline and/or hydrolysable polymer, elan alkoxyamine corresponding to the following formula (I): 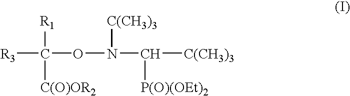
in which:
R₁ and R₃, which are identical or different, represent a linear or branched alkyl group having a number of carbon atoms ranging from 1 to 3;
R₂ represents a hydrogen atom, an alkali metal, an ammonium ion, a linear or branched alkyl group having a number of carbon atoms ranging from 1 to 8, or a phenyl group,
to form a medium;
b) bringing the medium resulting from stage a) into contact with one or more precursor monomers of the elastomeric block for a time sufficient to obtain a semicrystalline and/or hydrolysable block-b-elastomeric block diblock copolymer;
c) bringing the medium resulting from stage b) into contact with one or more precursor monomers of the amorphous block for a time sufficient to obtain the semicrystalline and/or hydrolysable block-b-elastomeric block-b-amorphous block triblock copolymer.

2. Process according to claim 1, in which the semicrystalline and/or hydrolysable polymer comprising a terminal ethylenic group is chosen from polycaprolactones, polylactides, polyethylene, polypropylene, polyethylene oxide and polyamides.

3. Process according to claim 1 or 2, additionally comprising, before stage a), a stage of functionalization of the semicrystalline and/or hydrolysable polymer, referred to as starting semicrystalline and/or hydrolysable polymer, intended to introduce the terminal ethylenic group.

4. Process according to claim 3, in which the starting semicrystalline and/or hydrolysable polymer is an co-hydroxylated polycaprolactone.

5. Process according to claim 1, in which the alkoxyamine used in stage a) corresponds to the following formula (II):

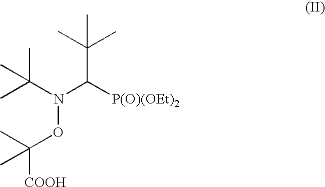

6. Process according to claim 1, in which the alkoxyamine is introduced, in stage a), in a content ranging from 0.5% to 80% by weight, with respect to the weight of the semicrystalline and/or hydrolysable polymer.

7. Process according to claim 1, in which the monomers introduced in stage b) which are precursors of the elastomeric block are chosen from alkyl acrylates or dienes.

8. Process according to claim 1, comprising the addition, during stage b), in addition to the monomers intended to constitute the elastomeric block, of a solution comprising a control agent corresponding to the following formula: 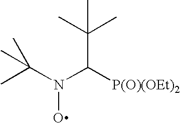
and a solvent for this control agent.

9. Process according to claim 1, in which the monomers introduced in stage c) which are precursors of the amorphous block are chosen from alkyl methacrylates, styrene, acrylic acid, alkylmethacrylamides or vinyl acetate.

10. Process according to claim 1, in which the semicrystalline and/or hydrolysable block is a polycaprolactone block, the elastomeric block is a poly(n-butyl acrylate) block and the amorphous block is a poly(methyl methacrylate) block.

11. Triblock copolymer obtained by a process as comprising the following stages:
a) adding b a 1,2-addition, to a terminal ethylenic group of a semicrystalline and/or hydrolysable polymer, an alkoxyamine corres n in to the following formula (I): 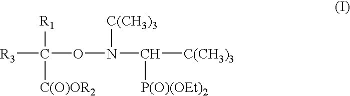
in which:
R₁ and R₃, which are identical or different, represent a linear or branched alkyl group having a number of carbon atoms ranging from 1 to 3
R₂ represents a hydrogen atom, an alkali metal, an ammonium ion, a linear or branched alkyl group having a number of carbon atoms ranging from 1 to 8, or a phenyl group,
to form a medium;
b) bringing the medium resulting from stage a) into contact with one or more precursor monomers of the elastomeric block for a time sufficient to obtain a semicrystalline and/or hydrolysable block-b-elastomeric block diblock copolymer;
c) bringing the medium resulting from stage b) into contact with one or more precursor monomers of the amorphous block for a time sufficient to obtain the semicrystalline and/or hydrolysable block-b-elastomeric block-b-amorphous block triblock copolymer.

12. (canceled)

13. Composite material comprising a matrix made of amorphous, thermosetting or semicrystalline polymer and a trib lock copolymer wherein said triblock copolymer is obtained by a process comprising the following stages:
a) adding by a 1,2-addition, to a terminal ethylenic group of a semicrystalline and/or hydrolysable polymer, an alkoxyamine corresponding to the following formula (I): 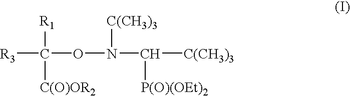
in which:
R₁ and R₃, which are identical or different, represent a linear or branched alkyl group having a number of carbon atoms ranging from 1 to 3;
R₂ represents a hydrogen atom, an alkali metal, an ammonium ion, a linear or branched alkyl group having a number of carbon atoms ranging from 1 to 8, or a phenyl group,
to form a medium;
b) bringing the medium resulting from stage a) into contact with one or more precursor monomers of the elastomeric block for a time sufficient to obtain a semicrystalline and/or hydrolysable block-b-elastomeric block diblock copolymer;
c) bringing the medium resulting from stage b) into contact with one or more precursor monomers of the amorphous block for a time sufficient to obtain the semicrystalline and/or hydrolysable block-b-elastomeric block-b-amorphous block triblock copolymer.

14. Composite material according to claim 13, in which the matrix made of amorphous, thermosetting or semicrystalline polymer is made of amorphous polymer.

15. Composite material according to claim 13, in which the matrix is made of polymethyl methacrylate.

16. The triblock copolymer according to claim 11 comprising a nanoporous film.

17. The triblock copolymer according to claim 11 comprising an antifouling paint.

18. The triblock copolymer according to claim 11 comprising an impact modifier used to enhance the impact and/or impact resistance properties and/or the mechanical strength properties of a polymer matrix.

19. The process according to claim 1 wherein said R₂ alkali metal is Li, Na or K, and said ammonium ion is NH₄⁺, NBu₄⁺ or NHBu₃⁺.
